(19) United States
(12) Patent Application Publication
(10) Pub. No.: US 2012/0185543 A1
(43) Pub. Date: Jul. 19, 2012

(54) APPARATUS AND METHOD FOR SHARING INFORMATION ON A WEBPAGE

(75) Inventors: Je-Young MAENG, Suwon-si (KR); Se-Hee Han, Seoul (KR)

(73) Assignee: Samsung Electronics Co., Ltd., Suwon-si (KR)

(21) Appl. No.: 13/280,909

(22) Filed: Oct. 25, 2011

(30) Foreign Application Priority Data
Jan. 18, 2011 (KR) 10-2011-0005098
Oct. 24, 2011 (KR) 10-2011-0108956

(51) Int. Cl. G06F 15/16

(52) U.S. Cl. 709/206; 709/224

(57) ABSTRACT

An apparatus and a method for sharing information on a webpage are provided. The method includes receiving webpage change information from a first electronic device; including the received webpage change information in a webpage change message and generating the webpage change message including the received webpage change information, for notifying the change of the webpage of the first electronic device, by a telephony control point; and transmitting the generated webpage change message to a second terminal.

### PRIORITY

This application claims priority under 35 U.S.C. §119(a) to Korean Patent Application filed in the Korean Intellectual Property Office on Jan. 18, 2011 and Oct. 24, 2011 and assigned Serial Nos. 10-2011-0005098 and 10-2011-0108956, respectively, the entire disclosures of which are incorporated herein by reference.

### BACKGROUND OF THE INVENTION

1. Field of the Invention

The present invention relates generally to an apparatus and method for sharing information on a webpage, and more particularly to an apparatus and method, by which a user can share information on a webpage displayed on a screen with another user in a home network while the user is talking to another user on the phone in the home network.

2. Description of the Related Art

Home networks often include Internet Protocol (IP)-based private networks. The home network connects various devices, including a Personal Computer (PC), an intelligent product, a wireless device and the like, which are used in a home, through a common virtual computing environment called middleware, into one network, and controls them.

The middleware connects various digital devices in the home network in a peer-to-peer scheme, so as to enable communication between them. Previously, Home Audio Video Interoperability (HAVI), Universal Plug and Play (UpnP), Java intelligent network infra-structure (Jini), Home Wide Web (HWW) and the like have been proposed as home network middleware.

A UPnP network, which is currently the most frequently used home networking technology, defines a UPnP device and a UPnP service, and defines a protocol between the UPnP device and the UPnP service. The UPnP network includes a Controlled Device (CD) corresponding to a home network device controlled while being connected to an IP-based home network, and a Control Point (CP) corresponding to a device for controlling the controlled device. The CP, which is a device for controlling the CD, requests an event from the controlled device and then receiving the requested event from the controlled device. The CD, which is a device for performing a function determined by the request of the CP, transmits the requested event to the control point, which has requested the event, when the state of the controlled device changes.

This UPnP telephony network technology enables a user to make or answer a phone call by using a television regardless of the type of a device in a house.

The UPnP telephony technology has an advantage in that it can be used in connection with not only a mobile telephony service but also the existing telephony technologies such as Voice over Internet Protocol (VoIP), Public Switched Telephone Network (PSTN), and the like.

As described above, when a user needs to explain a posting on a particular website to another user while the user is talking to another user on the telephone in a conventional UPnP network, there is inconvenience in that the user must verbally explain a link information of the particular posting, or the user must inform the other user of information regarding a webpage such as a Uniform Resource Locator (URL).

Also, when the user notifies another user of a URL, the user must verbally dictate the URL. The URL is too cumbersome to dictate to another user who is talking to the relevant user on the phone. Moreover, when the relevant user gives an incorrect URL to another user, the relevant user must repeat the URL.

### SUMMARY OF THE INVENTION

Accordingly, an aspect of the present invention is to solve the above-mentioned problems, and to provide an apparatus and a method, by which a user can share information on a webpage displayed on a screen with another user in a home network while the user is talking to another user on the phone in the home network.

In accordance with an aspect of the present invention, an apparatus for sharing information on a webpage is provided. The apparatus includes a web browser for browsing a webpage; a webpage change monitoring module for monitoring a change of the webpage at a preset period, and outputting webpage change information on a changed webpage when the webpage has been changed; and a telephony control point for transmitting the output webpage change information to a first terminal.

In accordance with an aspect of the present invention, an apparatus for sharing information on a webpage is provided. The apparatus includes a telephony service module for receiving webpage change information from a first electronic device; and a transmission/reception module for transmitting a webpage change message including the webpage change information to a second terminal.

In accordance with an aspect of the present invention, a method for sharing information on a webpage is provided. The method includes monitoring a change of a webpage in a web browser at a preset period; and transmitting webpage change information on a changed webpage to a first terminal when the webpage has been changed.

In accordance with an aspect of the present invention, a method for sharing information on a webpage is provided. The method includes receiving webpage change information from a first electronic device; including the received webpage change information in a webpage change message and generating the webpage change message including the received webpage change information, for notifying the change of the webpage of the first electronic device, by a telephony control point; and transmitting the generated webpage change message to a second terminal.

### BRIEF DESCRIPTION OF THE DRAWINGS

The above and other features, aspects, and advantages of the present invention will be more apparent from the following detailed description taken in conjunction with the accompanying drawings, in which:

FIG. 1 illustrates the configuration of a system for sharing information on a webpage according to an embodiment of the present invention;

FIG. 2 illustrates a configuration of an electronic device and a configuration of a terminal in a system for sharing information on a webpage according to an embodiment of the present invention;

FIG. 3 illustrates a sequence diagram illustrating a method for sharing information on a changed webpage in a system for sharing information on a webpage according to an embodiment of the present invention;

FIG. 4 illustrates a configuration of a system for sharing information on a webpage, which exchanges URL information, according to an embodiment of the present invention;

FIG. 5 is a block diagram illustrating a configuration of a system for sharing information on a webpage, which exchanges URL information, according to an embodiment of the present invention;

FIG. 6 illustrates a process for performing the synchronization (or sync) of a URL between TVs when a telephony control point is included in a mobile phone, according to an embodiment of the present invention;

FIG. 7 is a sequence diagram illustrating a configuration of a system for sharing information on a webpage, which exchanges URL information, when a telephony control point is included in an electronic device, according to an embodiment of the present invention; and

FIG. 8 is a sequence diagram illustrating a process for performing the synchronization of a URL between TVs when a telephony control point is included in an electronic device, according to an embodiment of the present invention.

### DETAILED DESCRIPTION OF EMBODIMENTS OF THE PRESENT INVENTION

Hereinafter, embodiments of the present invention will be described in detail with reference to the accompanying drawings. In the following description and the accompanying drawings, a detailed description of publicly-known functions and configurations which may unnecessarily obscure the subject matter of the present invention, will be omitted.

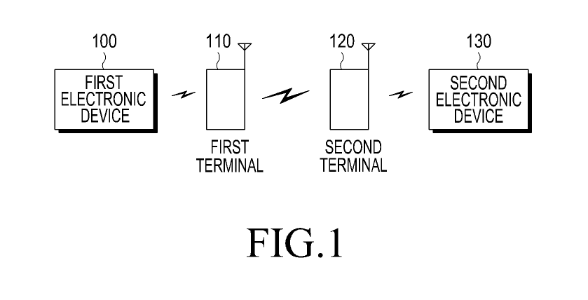

FIG. 1 illustrates the configuration of a system for sharing information on a webpage according to an embodiment of the present invention.

Referring to FIG. 1, a system for sharing information on a webpage according to the present invention includes a first electronic device 100, a first terminal 110, a second terminal 120, and a second electronic device 130.

The first electronic device 100 includes a household appliance such as a TeleVision (TV) and has a web browser, so that it displays a webpage according to an input of a user on a screen through the web browser.

When there is an input from the user for selecting another webpage, the first electronic device 100 displays another webpage changed according to the selected input through the web browser, and transmits information on the changed webpage to the first terminal 110.

The first terminal 110 requests connection information used to transmit data, from the second terminal 120 which is communicating with the first terminal 110 by the phone. When the first terminal 110 receives the requested connection information from the second terminal 120, the first terminal 110 transmits its connection information to the second terminal 120.

When the first terminal 110 has received the information on the changed webpage from the first electronic device 100, the first terminal 110 generates a webpage change message including the information on the changed webpage by using the connection information of the second terminal 120, and then transmits the generated webpage change message to the second terminal 120.

When the second terminal 120 receives the request for the connection information from the first terminal 110, the second terminal 120 transmits its connection information to the first terminal 110 in response to the request.

When the second terminal 120 receives the webpage change message from the first terminal 110, the second terminal 120 transmits the information on the changed webpage included in the received webpage change message to the second electronic device 130.

When the second electronic device 130 has received the information on the changed webpage from the second terminal 120, the second electronic device 130 changes a current webpage to a webpage corresponding to the information on the changed webpage.

According to the present invention, as described above, when the user changes a webpage that he or she is viewing while he or she is talking to his or her counterpart on the phone, a webpage that his or her counterpart is viewing is simultaneously changed, so that the user can conveniently explain the webpages to his or her counterpart while he or she is talking to his or her counterpart on the phone.

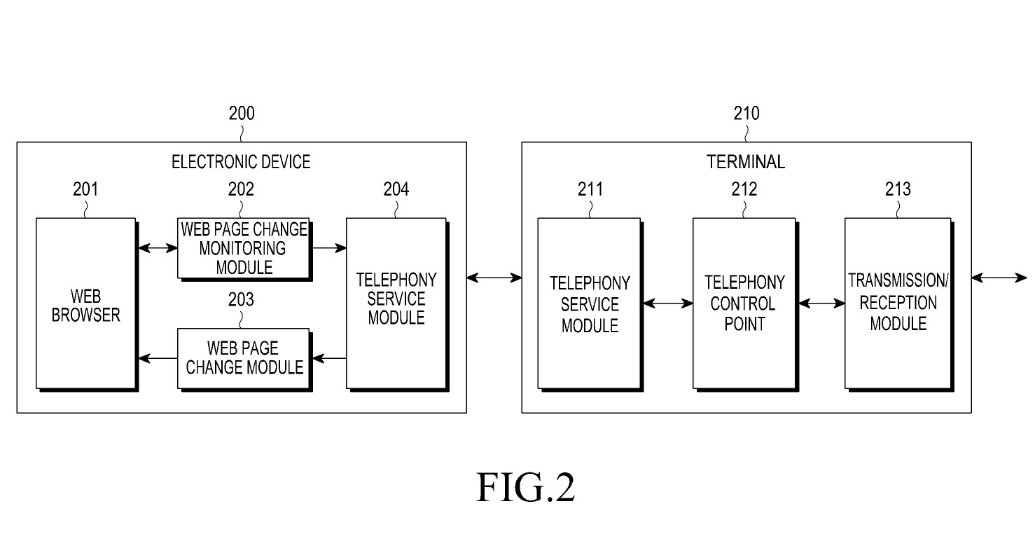

FIG. 2 is a block diagram illustrating a configuration of an electronic device and a configuration of a terminal in a system for sharing information on a webpage according to an embodiment of the present invention.

Referring to FIG. 2, an electronic device 200 includes a web browser 201, a webpage change monitoring module 202, a webpage change module 203, and a telephony service module 204.

The terminal 210 includes a telephony service module 211, a telephony control point 212, and a transmission/reception module 213.

The web browser 201 browses a webpage, and browses a webpage corresponding to information on a webpage to which the first webpage has been changed webpage.

The webpage change monitoring module 202 determines, at a preset period, whether a webpage displayed by a web browser has been changed.

When the change of a webpage is identified by the webpage change monitoring module 202, the webpage change module 203 transmits information on the changed webpage to the telephony service module 204. The information on the changed webpage may be a URL of the changed webpage.

Otherwise, when the webpage change module 203 has received information on a changed webpage transmitted by the telephony service module 204, the webpage change module 203 displays a webpage corresponding to the information on the changed webpage on a screen through the web browser 201.

The telephony service module 204 transmits the information on the changed webpage to the terminal 210.

Also, the telephony service module 211 of the terminal 210 transmits the information on the changed webpage received from the electronic device 200 to the telephony control point 212.

The telephony control point 212 generates a connection information request message for requesting connection information used to transmit data from another terminal which is connecting a phone call, and then transmits the generated connection information request message through the transmission/reception module 213. Otherwise, when the telephony control point 212 has received a request for connection information, the telephony control point 212 generates a connection information response message including connection information of the terminal 210, and then transmits the generated connection information response message through the transmission/reception module 213.

The transmission/reception module 213 transmits a connection information request message to another terminal, or receives a connection information response message from another terminal.

Moreover, the transmission/reception module 213 transmits a webpage change message to another terminal, or receives a webpage change message from another terminal.

As described above, when the user changes a webpage that he or she is viewing while he or she is talking to his or her counterpart on the phone, a webpage that his or her counterpart is viewing is simultaneously changed, so that the user can conveniently explain the webpages to his or her counterpart while he or she is talking to his or her counterpart on the phone.

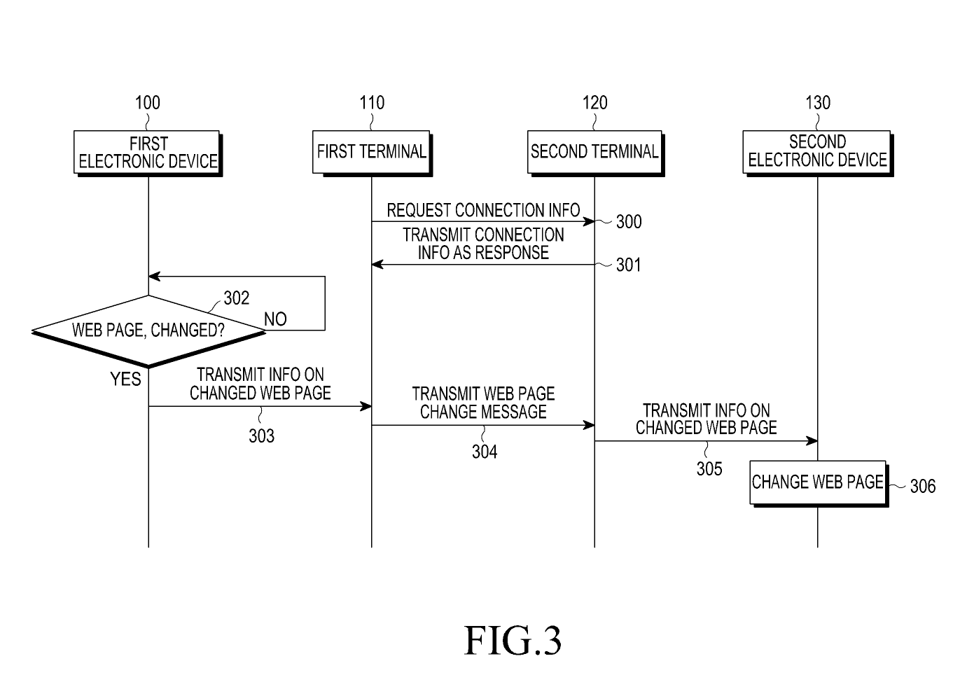

FIG. 3 is a sequence diagram illustrating a method of sharing information on a changed webpage in a system for sharing information on a webpage according to an embodiment of the present invention.

In an embodiment of the present invention, a first user is talking to a second user of the second terminal 120 on the phone by using the first terminal 110, a screen of the first electronic device 100 displays a webpage, and a screen of the second electronic device 130 also displays a webpage identical to the webpage displayed on the screen of the first electronic device 100.

Referring to FIG. 3, in step 300, the first terminal 110 requests connection information used to transmit data from the second terminal 120. The first terminal 110 generates a connection information request message for requesting the connection information of the second terminal 120, and then transmits the generated connection information request message to the second terminal 120. The connection information may be a Session Initiation Protocol (SIP) address capable of connecting to the second terminal 120. The first terminal 110 may transmit a SIP address to the second terminal 120 by using a Short Message Service (SMS) (i.e., text messaging).

In step 301, at the request of the first terminal 110, the second terminal 120 transmits its connection information to the first terminal 110. The second terminal 120 generates a connection information response message including its connection information, and then transmits the generated connection information response message to the first terminal 110. Furthermore, the second terminal 120 may transmit its SIP address to the first terminal 110 by using an SMS.

In step 302, the first electronic device 100 monitors, at a preset period, whether there is an input from a user for selecting another webpage. When a current webpage is changed, the process proceeds to step 303. Otherwise, the first electronic device 100 continuously monitors whether there is an input from the user for selecting another webpage.

In step 303, the first electronic device 100 transmits information on the changed webpage to the first terminal 110. In particular, the first electronic device 100 generates a webpage change information message including the information on the changed webpage, and then transmits the generated webpage change information message to the first terminal 110.

In step 304, the first terminal 110 transmits the received webpage change message to the second terminal 120 by using the connection information of the second terminal 120 received in step 301. In other words, in order to notify the second terminal of the change of the webpage, the first terminal 110 transmits a webpage change message including the information on the changed webpage. The first terminal 110 transmits a URL of the changed webpage which has been changed to a SIP address of the second terminal 120 through a UPnP event mechanism.

In step 305, the second terminal 120 transmits the information on the changed webpage to the second electronic device 130. The second terminal 120 transmits a URL of the changed webpage, which has been changed to a SIP address of the second terminal 120 through the UPnP event mechanism, to the second electronic device 130.

In step 306, the second electronic device 130 changes a current webpage to a webpage corresponding to the information on the changed webpage.

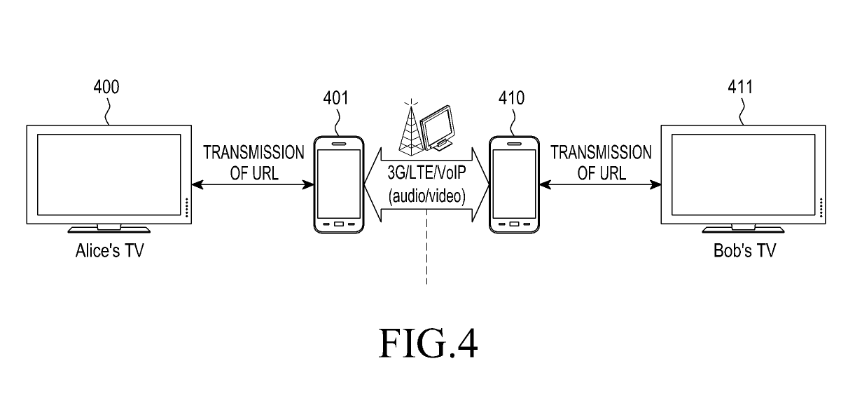

FIG. 4 illustrates the configuration of a system for sharing information on a webpage, which exchanges URL information, according to an embodiment of the present invention.

A system for sharing information on a webpage, according to the present invention, includes Alice's TV 400, Alice's phone 401, Bob's phone 410, and Bob's TV 411.

Alice's TV 400 has a web browser, and displays a webpage according to an input from a user on a screen through the web browser.

When there is an input from the user for selecting another webpage, Alice's TV 400 displays another webpage to which the first webpage has been changed according to the selected input through the web browser, and transmits a URL of the changed webpage to Alice's phone 401.

Alice's phone 401 requests connection information used to transmit data from Bob's phone 410 which is communicating with Alice's phone 401. When Alice's phone 401 has received the requested connection information from Bob's phone 410, Alice's phone 401 transmits connection information thereof to Bob's phone 410.

When Alice's phone 401 has received the URL of the changed webpage from Alice's TV 400, Alice's phone 401 transmits the URL of the changed webpage to Bob's TV 411 by using the connection information of Bob's phone 410.

When Bob's phone 410 has received the request for the connection information from Alice's phone 401, Bob's phone 410 transmits connection information thereof to Alice's phone 401 at the request.

When the Bob's phone 410 has received the URL of the changed webpage from Alice's phone 401, Bob's phone 410 transmits the received URL of the changed webpage to Bob's TV 411.

When Bob's TV 411 has received the URL of the changed webpage from Bob's phone 410, Bob's TV 411 changes a current webpage to a webpage corresponding to the URL of the changed webpage.

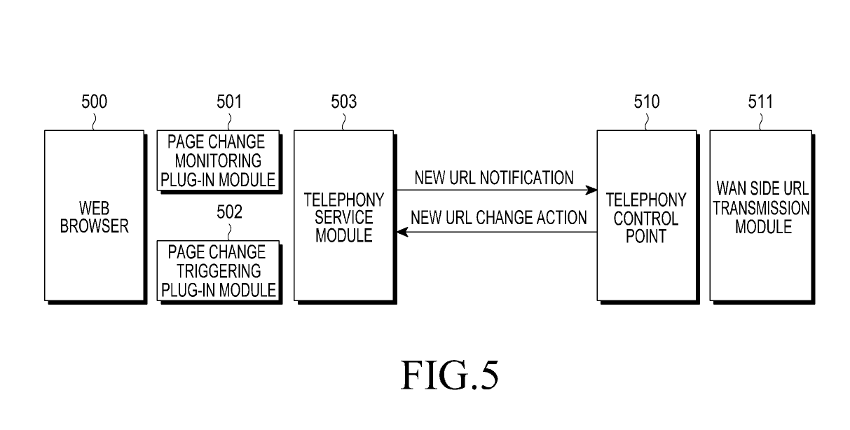

FIG. 5 is a block diagram illustrating a specific configuration of a system for sharing information on a webpage, which exchanges URL information, according to an embodiment of the present invention.

A system for sharing information on a webpage, according to the present invention, includes an electronic device-, which includes a web browser 500, a page change monitoring plug-in module 501, a page change triggering plug-in module 502 and a telephony service module 503, and a terminal which includes a telephony control point 510 and a Wide Area Network (WAN) side URL transmission module 511.

The configuration of the electronic device 200 will be described as follows. The web browser 500 browses a webpage, and browses a webpage corresponding to information on a changed webpage.

The page change monitoring plug-in module 501 identifies, at a preset period, whether a webpage displayed in the web browser has been changed.

When the change of a webpage has been identified by the page change monitoring plug-in module 501, the page change triggering plug-in module 502 delivers information on the changed webpage to the telephony service module 503. The information on the changed webpage may be a URL of the changed webpage.

Moreover, when the information on the changed webpage has been delivered by the telephony service module 503, the page change triggering plug-in module 502 displays a webpage corresponding to the information on the changed webpage on a screen through the web browser 500.

The telephony service module 503 delivers the information on the changed webpage to the telephony control point 510 of the terminal 210.

The telephony control point 510 of the terminal 210 requests the WAN-side URL transmission module 511 to transmit data.

The WAN-side URL transmission module 511 delivers a webpage change message to another terminal, or receives a webpage change message from another terminal.

In the configuration as described above, when the current webpage is changed to a new webpage, the electronic device transmits a new URL notification notifying the new webpage, to the terminal, and the terminal then transmits an action for changing the current URL to a new URL in response to the change to the new webpage, to the electronic device.

According to the present invention, each mobile Telephone Control Point (TelCP) phone device may search for a device having the capability of monitoring the update of a browser.

Each mobile phone knows an identity used to establish a data transmission channel. A data transmission channel may be used to transmit URL update information of a television, which is a device for sharing a webpage, and a message related to a UPnP action call. A Multimedia Messaging Service (MMS) or another device supports a state in which a new action and the exchange of an updated URL between a mobile phone and a television are diversified.

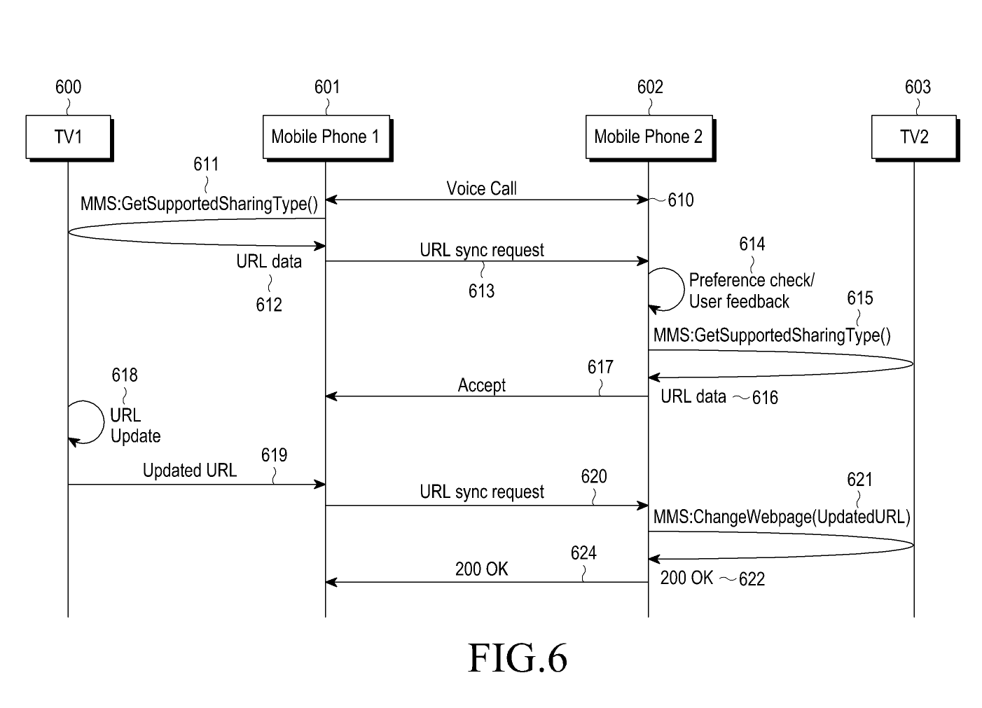

FIG. 6 illustrates a process for performing the synchronization (or sync) of a URL between TVs when a telephony control point is included in a mobile phone, according to an embodiment of the present invention.

In step 610, mobile phone 1 601 and mobile phone 2 602 perform a voice call.

In step 611, mobile phone 1 601 calls a getSupportedSharingType( ) function by using a message service such as a MMS within a Telephony Client (TC) included in TV 1 600. Herein, the getSupportedSharingType( ) is a function for recognizing a content type supported by a content sharing function of TV 1 600. The content which can be shared, include files, images, music, webpage address data (i.e. webpage URL data), and the like.

When TV 1 600 has a function for webpage synchronization, in step 612, TV 1 600 delivers URL data to mobile phone 1 601.

In step 613, mobile phone 1 601 transmits a URL synchronization request message to mobile phone 2 602. Such a URL synchronization request message is a message for establishing a URL synchronization session on a WAN-side, and different technologies may be used according to mobile phones in connection with a URL synchronization request message.

In step 614, in order to query a user whether the user is to use a URL synchronization function, mobile phone 2 602 performs a preference check, and determines based on user feedback whether the user is to use a function of mobile phone 2 602 itself or is to use a URL synchronization service while being connected with an electronic device such as TV 2 603 in a house.

When the user selects TV 2 603 as a synchronization device for URL synchronization, in step 615, mobile phone 2 602 calls the getSupportedSharingType( ) function by using a message service such as an MMS in TV 2 603 similarly to step 620.

In step 616, TV 2 603 delivers URL data to mobile phone 2 602 in response to the request. In step 617, mobile phone 2 602 delivers, to mobile phone 1 601, an accept message, notifying that a URL synchronization session has been set. In step 618, TV 1 600 updates a URL, and transmits the updated URL to mobile phone 1 601 in step 619. In step 620, mobile phone 1 601 transmits a URL synchronization message including the updated URL to mobile phone 2 602.

In step 621, mobile phone 2 602 calls Change WebPage(UpdatedURL) including the updated URL as a parameter and delivers the updated URL to TV 2 603, by using a message service such as an MMS in TV 2 603. And TV 2 603 updates the current URL to the received updated URL.

In step 622, TV 2 603 delivers a 200 OK response message to mobile phone 2 602. In step 624, mobile phone 2 602 delivers the 200 OK response message to mobile phone 1 601.

WAN-side exchanges messages according to X Display Manager (XDM) standard of the Open Mobile Alliance (OMA) standard.

The above description has been made of an example where a telephony control point is included in a mobile phone. In the following embodiment, a description will be made of a process for performing the synchronization of a URL between TVs when a telephony control point is included in an electronic device such as a television.

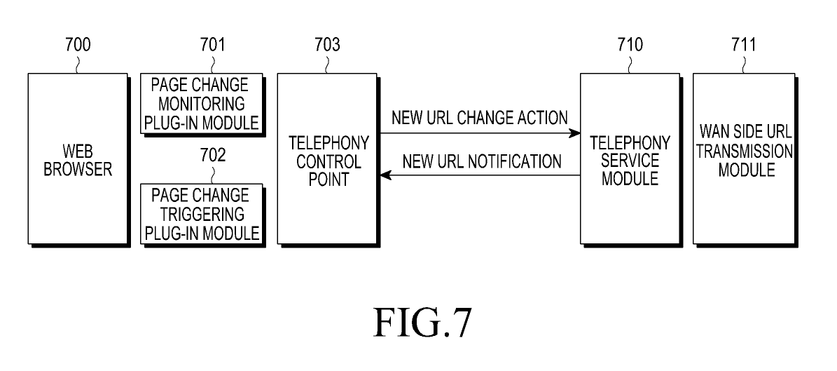

FIG. 7 is a sequence diagram illustrating a specific configuration of a system for sharing information on a webpage, which exchanges URL information, when a telephony control point is included in an electronic device, according to an embodiment of the present invention.

A system for sharing information on a webpage according to the present invention includes an electronic device, which includes a web browser 700, a page change monitoring plug-in module 701, a page change triggering plug-in module 702 and a telephony control point 703, and a terminal which includes a telephony service module 710 and a WAN-side URL transmission module 711.

The configuration of the electronic device will be described as follows. The web browser 700 browses a webpage, and browses a webpage corresponding to information on a changed webpage.

The page change monitoring plug-in module 701 identifies at a preset period whether a webpage displayed in the web browser has been changed.

When the change of a webpage has been identified by the page change monitoring plug-in module 701, the page change triggering plug-in module 702 delivers information on the changed webpage to the telephony control point 703. The information on the changed webpage may be a URL of the changed webpage.

Also, when the information on the changed webpage has been delivered by the telephony control point 703, the page change triggering plug-in module 702 displays a webpage corresponding to the information on the changed webpage on a screen through the web browser 700.

The telephony control point 703 delivers the information on the changed webpage to the telephony service module 710 of the terminal 210. The telephony service module 710 of the terminal 210 requests the WAN-side URL transmission module 711 to transmit data.

The WAN-side URL transmission module 711 delivers a webpage change message to another terminal, or receives a webpage change message from another terminal.

In the configuration as described above, when the current webpage is changed to a new webpage, the electronic device transmits a new URL change action for notifying the new webpage, to the terminal, and the terminal then transmits a new URL notification of the change to the new webpage, to the electronic device.

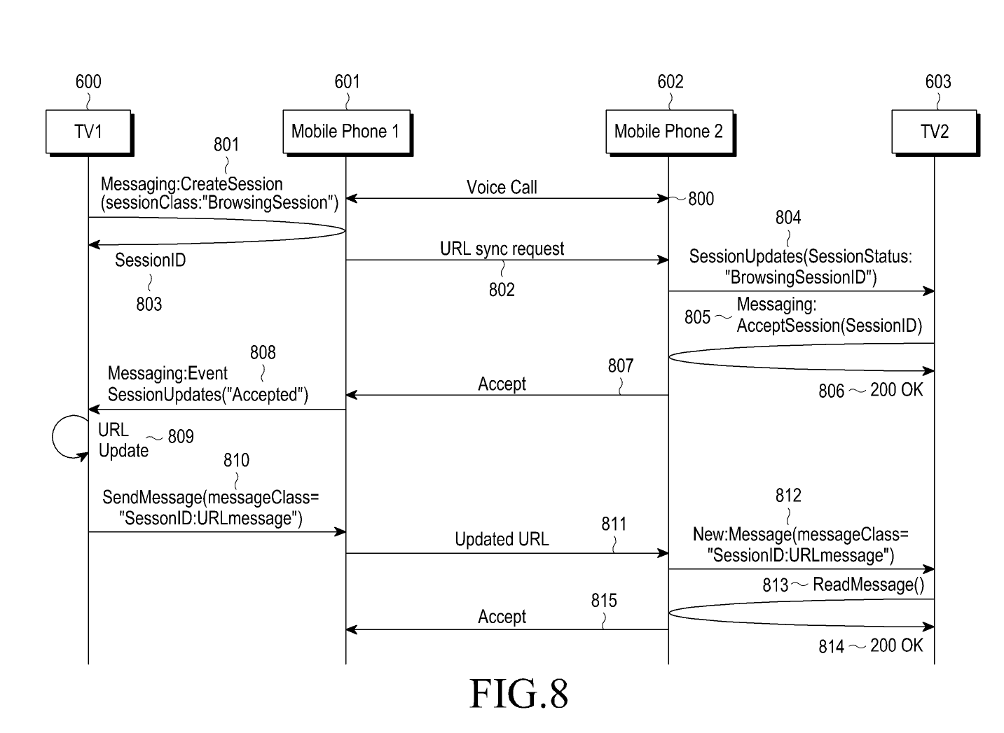

FIG. 8 is a sequence diagram illustrating a process for performing the synchronization of a URL between TVs when a telephony control point is included in an electronic device, according to an embodiment of the present invention.

In step 800, mobile phone 1 601 and mobile phone 2 602 perform a voice call.

In step 801, TV 1 600 calls a CreateSession(sessionClass: “BrowsingSession”) function by using a messaging service on mobile phone 1 601. Herein, the CreateSession(sessionClass: “BrowsingSession”) call signifies an action for establishing a session of browsing a webpage.

In step 802, mobile phone 1 601 which has received the action, delivers a URL synchronization request message, which is a message for requesting the establishment of a session for synchronization of a webpage URL, to mobile phone 2 602.

In step 803, mobile phone 1 601 allocates a first session ID to the above session in order to distinguish it from other sessions, and delivers the first allocated session ID to TV 1 600 in response to the CreateSession(sessionClass: “BrowsingSession”) call.

In step 804, mobile phone 2 602 delivers a SessionUpdates(SessionStatus: “BrowsingSession”) event indicating the arrival of the URL synchronization message to TV 2 603. Mobile phone 2 602 allocates a second session ID to the latter session in order to distinguish it from other sessions, and includes the second allocated session ID in the event and delivers the event including the second allocated session ID to TV 2 603.

When a user allows the request for establishing the URL synchronization session, in step 805, TV 2 603 delivers AcceptSession(sessionID) including the second received session ID to mobile phone 2 602, and notifies of the establishment of the URL synchronization session.

In step 806, mobile phone 2 602 delivers a 200 OK response message, which is a response to the above action, to TV 2 603. In step 807, mobile phone 2 602 delivers an accept message for notifying the setting of the URL synchronization session to mobile phone 1 601. In step 808, mobile phone 1 601 delivers a SessionUpdates(“Accepted”) event to TV 1 600, and notifies the setting of the requested URL synchronization session.

When a webpage has been changed during the browsing of a webpage by the user, in step 809, TV 1 600 updates the current URL to a URL of the changed webpage.

In step 810, TV 1 600 delivers SendMessage(messageClass=“SessionID:URLmessage”) function including the updated URL of the changed webpage to mobile phone 1 601.

In step 811, mobile phone 1 delivers 601 a message including the updated URL to mobile phone 2 602.

In step 812, mobile phone 2 602 delivers NewMessage(messageClass=“SessionID:URLmessage”) function, which is an event message including the updated URL, to TV 2 603.

In step 813, when URL information is included in the event message, TV 2 603 indicates through ReadMessage( ) that the event message has been read. However, when the URL information is not included in the event message, TV 2 603 receives an actual message through the ReadMessage( ) function.

In step 814, mobile phone 2 602 delivers a 200 OK response message to TV 2 603 in response to ReadMessage( ). In step 815, mobile phone 2 602 delivers an accept message, which is a response message to the delivery of the updated URL, to mobile phone 1 601.

According to the present invention, as described above, when the user changes a webpage that he or she is viewing while he or she is talking to his or her counterpart on the phone, a webpage that his or her counterpart is viewing is simultaneously changed, so that the user can conveniently explain the webpages to his or her counterpart while he or she is talking to his or her counterpart on the phone.

Hence, according to the present invention, when the user views a webpage in the same manner as his or her counterpart views a webpage by using an electronic device, while he or she is talking to his or her counterpart on the phone, a webpage that his or her counterpart is viewing is changed together with the change of a webpage that the user is viewing. Therefore, the user can conveniently explain an identical webpage to his or her counterpart while the user and his or her counterpart simultaneously view the identical webpage.

While the invention has been shown and described with reference to certain embodiments thereof, it will be understood by those skilled in the art that various changes in form and details may be made therein without departing from the spirit and scope of the invention. Therefore, the spirit and scope of the present invention is not limited to the described embodiments thereof, but is defined by the appended claims and their equivalents.

What is claimed is:

1. An apparatus for sharing information on a webpage, the apparatus comprising:
a web browser for browsing a webpage;
a webpage change monitoring module for monitoring a change of the webpage at a preset period, and outputting webpage change information of a second electronic device regarding a changed webpage when the webpage has been changed; and
a telephony control point for transmitting the output webpage change information to a first terminal.

2. The apparatus of claim 1, further comprising:
a webpage change module for changing a webpage in the web browser by using the received webpage change information of the second electronic device,
wherein the telephony control point receives the webpage change information of the second electronic device from the first terminal.

3. The apparatus of claim 1, wherein the webpage change information includes a Uniform Resource Locator (URL) of the changed webpage.

4. An apparatus for sharing information on a webpage, the apparatus comprising:
a telephony service module for receiving webpage change information from a first electronic device; and
a transmission/reception module for transmitting a webpage change message including the webpage change information to a second terminal.

5. The apparatus of claim 4, wherein the webpage change message includes information on the changed webpage of the first electronic device.

6. The apparatus of claim 4, wherein the transmission/reception module receives a response message to the webpage change message from the second terminal.

7. A method for sharing information on a webpage, the method comprising:
monitoring a change of a webpage in a web browser at a preset period; and
transmitting webpage change information on a changed webpage to a first terminal when the webpage has been changed.

8. The method of claim 7, further comprising:
changing a webpage in the web browser by using received webpage change information of a second electronic device when webpage change information of the second electronic device has been received from the first terminal.

9. The method of claim 7, wherein the webpage change information includes a Uniform Resource Locator (URL) of the changed webpage.

10. A method for sharing information on a webpage, the method comprising:
receiving webpage change information from a first electronic device;
including the received webpage change information in a webpage change message and generating the webpage change message including the received webpage change information, for notifying the change of the webpage of the first electronic device, by a telephony control point; and
transmitting the generated webpage change message to a second terminal.

11. The method of claim 10, wherein the webpage change message includes information on the changed webpage of the first electronic device.

12. The method of claim 10, further comprising:
receiving a response message to the webpage change message from the second terminal.
